(19) United States
(12) Patent Application Publication
(10) Pub. No.: US 2004/0231741 A1
(43) Pub. Date: Nov. 25, 2004

(54) Pipe fracture safety for a vacuum-insulated filling line

(76) Inventors: Harald Kraus, Munchen (DE); Wilfried-Henning Reese, Unterchleisshem (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/474,061

(22) PCT Filed: Apr. 5, 2002
(86) PCT No.: PCT/EP02/03773

(30) Foreign Application Priority Data
Apr. 6, 2001 (DE) 101 17 329.6

(51) Int. Cl. F16L 55/00

(52) U.S. Cl. 138/104

(57) ABSTRACT

The invention relates to a vacuum-insulated filling line, especially for cryogenic media, preferably for liquefied and/or gaseous, highly-pressurized hydrogen. The invention also relates to a filling station for cryogenic media, having said vacuum-insulated filling line. According to the invention, the vacuum-insulated filling line has a pipe fracture safety. Said pipe fracture safety can be embodied in the shape of a guide pipe (5) arranged on the outer wall (1) of the filling line, a bellows (6) arranged in the guide pipe (5) and firmly connected to the outer wall (1) of the filling line, a (contact) plate (7) closing the bellows (6) and a device assigned to the (contact) plate (7), which is configured to detect movement of the (contact) plate (7) and/or the bellows (6).

The invention relates to a vacuum-insulated filling line, especially for cryogenic media, preferably for liquified and/or gaseous hydrogen under high pressure.

The invention also relates to a filling station for cryogenic media.

In the designations of special cryogenic media below according to their aggregate state, the letter “G” is prefixed for “gaseous” and the letter “L” for “liquid”; therefore, for example, GH₂ or LH₂ for gaseous and liquid hydrogen respectively.

The concept of “cryogenic medium” or “cryogenic media” is to be understood below also as liquefied and gaseous natural gas.

In particular, hydrogen is currently becoming more important as an energy source due to increasing energy demand and increased environmental consciousness. Thus, initial tests are underway for propelling aircraft, trucks, buses and passenger cars by means of hydrogen-driven turbines or engines. Furthermore, vehicles are already being field-tested in which a fuel cell produces electrical energy that in turn drives an electric motor. The hydrogen necessary for operation of the fuel cell is stored in these vehicles either in liquid or gaseous and compressed form.

The required filling stations for cryogenic media are to be designed as self-service filling stations for the foreseeable future; to date, fueling of motor vehicles at the few experimental filling stations has been done solely by trained technical personnel.

Transfer of the cryogenic medium with which the motor vehicle is to be fuelled from the storage tank of the filling station to the actual vehicle storage tank takes place by means of vacuum-insulated filling lines that—depending on the filling process used—are made single-core or multi-core. It is common to all of them, however, that they are vacuum-insulated in order to minimize the incidence of heat onto the cryogenic medium and thus into the motor vehicle storage tank.

If a leak occurs in the outside wall of the vacuum-insulated filling line, the filling line breaks or the cryogenic medium penetrates into the vacuum-insulated area of the filling line; this insulation thus is lost, and sudden vaporization of the cryogenic medium may occur.

The object of this invention is to devise a generic vacuum-insulated filling line for cryogenic media that detects the occurrence of one of the aforementioned defects and enables corresponding measures to be initiated.

To achieve this object, a vacuum-insulated filling line for cryogenic media is proposed that is characterized in that it has a line rupture safeguard. The expression “line rupture safeguard” is defined here as a safeguard that can detect at least the aforementioned defects.

The line rupture safeguard is made here in the form of a guide pipe that is located on the outside wall of the filling line, a bellows that is permanently connected to the outside wall of the filling line and that is located in the guide pipe, a (contact) plate that seals the bellows, and a device that is assigned to the (contact) plate and that is made for detecting the motion of the (contact) plate.

As already mentioned, the invention relates to a generic filling station for cryogenic media that enables filling of motor vehicles with cryogenic media by untrained personnel and by the customer.

To achieve this object, a filling station for cryogenic media is proposed that is characterized in that it has at least one vacuum-insulated filling line according to the invention.

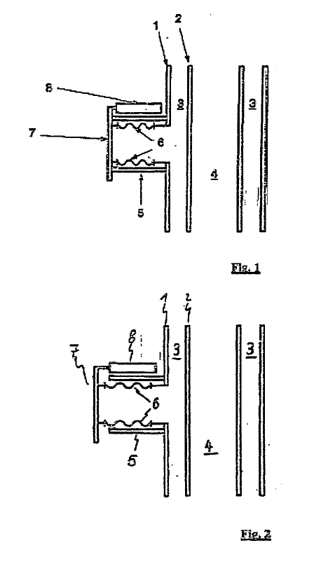

The vacuum-insulated filling line according to the invention for cryogenic media as well as other embodiments thereof are detailed based on the embodiment shown in FIGS. 1 and 2.

FIGS. 1 and 2 show a lateral sectional view through one embodiment of the vacuum-insulated filling line according to the invention, the line rupture safeguard in FIG. 1 being shown in an activated state, while the identical line rupture safeguard in FIG. 2 is shown in an inactivated state.

The vacuum-insulated filling line that is single-core in this case has an outside wall 1 and a media line 2 that is arranged concentrically to it. If the filling line is made twin-core or multi-core, the lines are located either next to one another or inside one another. The interior 4 of the media line 2 is used to transfer the cryogenic medium. The annular space 3 is vacuum-insulated for the aforementioned reasons.

According to the invention, on the outside wall 1 of the filling line there is now a guide pipe 5. In this guide pipe 5, there is bellows 6 that is connected permanently to the outside wall 1. The bellows 6 is for this purpose welded preferably to the outside wall 1. It consists, moreover, preferably of a metallic material, but other materials, such as for example plastic materials, are also conceivable.

The bellows 6 is sealed by a so-called contact plate 7, the bellows 6 and contact plate 7 in turn preferably being welded to one another.

To the contact plate 7 according to the invention is assigned a device that is made for detecting the motion of the contact plate 7. Especially a pneumatic contactor 8 as is shown in FIGS. 1 and 2 is suitable as such a device.

In addition, however, other devices that are suitable for detecting the motion of the (contact) plate 7 and/or of the bellows 6 can also be used. These are, for example, electrical contactors, electrical proximity contact switches or magnetically activated sensors.

As a result of the vacuum in the annular space 3 of the filling line according to the invention, the bellows 6 is contracted. The contact plate thus rests on the guide pipe 5 and activates the pneumatic contactor 8.

If now, as a result of a leak in the outside wall 1, a breaking of the filling line according to the invention, or a penetration of the cryogenic medium from the space 4 into the annular space 3, the vacuum is lost, the bellows 6 relaxes—as is shown in FIG. 2—according to the designed spring length or strength since the force tightening it is no longer present. Due to the loss of the vacuum and the associated relaxation of the bellows 6, the contact plate 7 is guided away from the pneumatic contactor 8 so that the latter is no longer activated..

The pneumatic contactor 8 is linked to the control of the filling station such that in the case of deactivation of the pneumatic contactor 8 via a corresponding (emergency) switching, the feed of cryogenic medium into the filling line according to the invention is interrupted, and optionally the filling station is shifted into a safe operating state.

It is, moreover, conceivable that—if there is a corresponding check valve in the motor vehicle that is to be fuelled—this check valve closes likewise in the case of deactivation of the pneumatic contactor 8 in order to prevent unwanted heat incidence into the motor vehicle storage tank. This, however, presupposes that the pneumatic contactor 8 and/or the control of the filling station are connected to the check valve of the motor vehicle or to its control.

The vacuum-insulated filling line according to the invention for cryogenic media enables safe filling of motor vehicles with cryogenic media even by untrained personnel. In this way, the acceptance for filling stations that are used to fuel motor vehicles with cryogenic media is increased, their operation is facilitated, and it becomes possible to design such filling stations as self-service filling stations.

The inventive idea can be implemented in addition to the aforementioned vacuum-insulated filling lines for cryogenic media basically in all vacuum-insulated lines—regardless of their application.

1. In a vacuum-insulated filling line, the improvement wherein the vacuum-insulated filing line has a line rupture safeguard.

2. A vacuum-insulated filling line according to claim 1, wherein the line rupture safeguard comprises a guide pipe (5) that is located on the outside wall (1) of the filing line, a bellows (6) that is permanently connected to the outside wall (1) of the filling line and that is located in the guide pipe (5), a (contact) plate (7) that seals the bellows (6) and a device that is assigned to the (contact) plate (7) and that is made for detecting the motion of the (contact) plate (7) and and/or the bellows (6).

3. A vacuum-insulated filling line according to claim 1, wherein the device that is assigned to the contact plate (7) and that is made for detecting the motion of the contact plate (7) and/or of the bellows (6) is a pneumatic contactor (8), an electrical contactor, an electrical proximity contact switch or a magnetically activated sensor.

4. A vacuum-insulated filling line according to claim 1, wherein the bellows (6) consists of a metallic material and/or a plastic material.

5. In a filling station for delivering cryogenic media to vehicles, the improvement, wherein the filling station has at least one vacuum-insulated filling line according to claim 1.

6. A filling station for deliveries cryogenic media according to claim 5, wherein the filling station has means for recognizing or detecting of the activation and/or deactivation of the line rupture safeguard.

7. A vacuum insulated filling line according to claim 3, wherein the device that is assigned to the (contact) plate (7) and that is made for detecting the motion of the (contact) plate (7) and/or of the bellows (6) is a pneumatic contactor (8), an electrical contactor, an electrical proximity contact switch or a magnetically activated sensor.

8. A vacuum-insulated filling line according to claim 1, wherein said filling line is connected to a source of cryogenic media.

9. A vacuum-insulated filling line according to claim 8, wherein said cryogenic media is liquefied hydrogen.

10. A vacuum-insulated filling line according to claim 8, wherein said cryogenic media is gaseous hydrogen.

11. A vacuum insulated filling line according to claim 2, wherein the bellows (6) consists of a metallic material and/or a plastic material.

12. A vacuum insulated filling line according to claim 3, wherein the bellows (6) consists of a metallic material and/or a plastic material.

13. A vacuum insulated filling line according to claim 7, wherein the bellows (6) consists of a metallic material and/or a plastic material.

14. In a filling station for delivering cryogenic media the improvement to vehicles, wherein the filling station has at least one vacuum-insulated filling line according to claim 2.

15. In a filling station for delivering cryogenic media the improvement to vehicles, wherein the filling station has at least one vacuum-insulated filling line according to claim 3.

16. In a filling station for delivering cryogenic media the improvement to vehicles, wherein the filling station has at least one vacuum-insulated filling line according to claim 7.

17. A filling station for delivering cryogenic media according to claim 14, wherein the filling station has means for recognizing or detecting of the activation and/or deactivation of the line rupture safeguard.

18. A filling station for delivering cryogenic media according to claim 15, wherein the filling station has means for recognizing or detecting of the activation and/or deactivation of the line rupture safeguard.

19. A filling station for delivering cryogenic media according to claim 16, wherein the filling station has means for recognizing or detecting of the activation and/or deactivation of the line rupture safeguard.
